(19) United States
(12) Patent Application Publication
(10) Pub. No.: US 2003/0221847 A1
(43) Pub. Date: Dec. 4, 2003

(54) Pneumatic percussion operated mechanism

(76) Inventor: Josef Funfer, Konigsbrunn (DE)

Correspondence Address: DAVID TOREN, ESQ., SIDLEY, AUSTIN, BROWN & WOOD, LLP, 787 SEVENTH AVENUE, NEW YORK, NY, 10019-6018, US

(21) Appl. No.: 10/376,007

(22) Filed: Feb. 27, 2003

(30) Foreign Application Priority Data
Mar. 1, 2002 (DE) 102 09 293.1

(51) Int. Cl. B25D 9/00

(52) U.S. Cl. 173/201; 173/128

(57) ABSTRACT

A pneumatic percussion operated mechanism for an at least partially percussion driven hand tool device (1) has a cup-shaped piston (2), in whose hollow space (4) an anvil (3) spaced radially inwardly displaceably penetrates inwardly within an axial penetration length (L), whereby the anvil (3) forms, together with the cup-shaped piston (2), a damping radial gap (X) relative to the essentially gas-tight, closed hollow space (4), which forces anvil (3) axially driven by the piston (2) inside the penetration length (L) to reversal of direction.

### BACKGROUND OF THE INVENTION

The invention relates to a pneumatic percussion operated mechanism for an at least partially percussion driven hand tool device such as a chisel hammer or a hammer drill.

A pneumatic percussion operated mechanism has a free piston guided in a guide tube and driven by an air spring, the free piston conventionally impacting upon an anvil movable for a limited axial extent, itself abutting on the trailing end of a tool movable for a limited axial extent.

According to DE 2702128 a pneumatic percussion operated mechanism formed as short as possible for a hammer drill features a cup-shaped free piston in which an anvil penetrates axially inwardly. Other hollow, cup-shaped free pistons the arranged on the anvil side have been described in JP 8141937 and JP 7328955.

In the case of pneumatic percussion operated mechanisms and under certain working conditions such as inadequate counter pressure from the workpiece re-striking of the anvil by the tool may occur, which is prevented according to DE 3804026 by using air passages in the free piston and a rotationally displaceable guide tube.

### SUMMARY OF THE INVENTION

The object of the invention is to provide a technically simple development of a pneumatic percussion operated mechanism that is short in its construction and free of idling.

Essentially, a pneumatic percussion operated mechanism for an at least partially percussion operated hand tool machine has a cup-shaped piston forming a hollow space, an anvil penetrates displaceably axially inwardly within an axial penetration length and, together with the latter forms a damping, pneumatically acting radially extending gap relative to the essentially gas-tight closed hollow space, which drives the anvil, driven by the piston within the penetration length, to the reversal movement.

By virtue of the damping, pneumatically acting radial gap due to the high flow resistance towards the hollow space, after the percussion strike of the piston on the anvil, there is a suction effect between the essentially gas-tight, closed hollow space of the piston and the anvil, whereby at the operating point there is substantially no braking of the anvil; however, in the case of a no-load strike it reverses its direction of movement before the contact on the trailing end of the tool, whereby with sufficient boring capacity an optimum idling behavior is obtained.

Advantageously the gap area of the radial annular gap between the anvil and the piston is 3% to 6% of the anvil cross-section area formed by the anvil inside the piston, whereby in the case of normal percussion frequencies of 50 Hz to 100 Hz a reversal of movement occurs within 10 mm.

Advantageously in the case of conventional pneumatic percussion operated mechanisms for hand tool machines having an anvil weighing approximately 50 g penetrating into the piston and a pneumatically acting diameter of approximately 10 mm, the gap thickness is in the range of 0.1 mm to 0.17 mm, whereby optimum results have been obtained in a series of trials.

### BRIEF DESCRIPTION OF THE DRAWINGS

The drawings show:

FIG. 1 is a sectional view of a percussion operated mechanism, and

FIG. 2 is an enlarged partial sectional view of a single unit II, in FIG. 1.

### DETAILED DESCRIPTION OF THE INVENTION

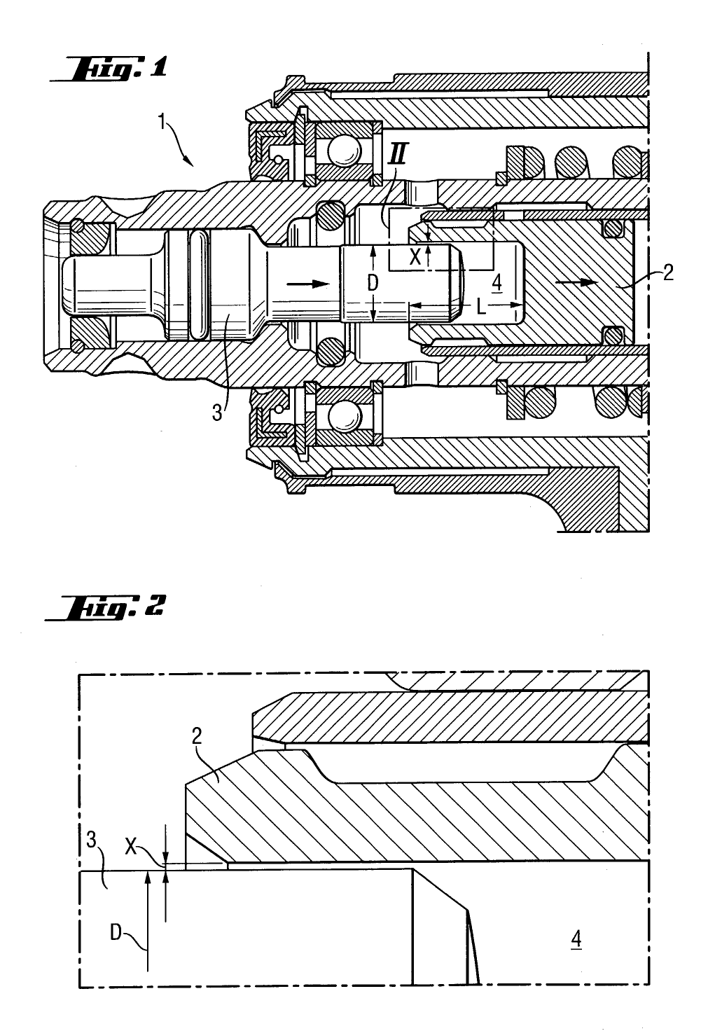

FIG. 1 is a pneumatic percussion operated mechanism of a percussion driven hand tool machine 1 having a cup-shaped piston 2 at the no-load strike movement reversal point, in which an anvil 3 is spaced radially inwardly of the cup-shaped piston and displaceably penetrates into an axial penetration length L, forming, over a portion of its outer sleeve length together with a portion of the inner sleeve length of the piston 2, a damping, pneumatically acting radial gap X relative to an essentially gas-tight, closed hollow space 4 within the piston 2.

According to FIG. 2, in the case of a pneumatically effective diameter D of the anvil 3 of approximately 10 mm, the thickness of the damping, radial gap X is the range of 0.1 mm to 0.17 mm.

What is claimed is:

1. A pneumatic percussion operated mechanism for or at least partially percussion driven hand tool device having an axially extending piston (2) cup-shaped at a leading end thereof and forming an axially extending hollow space (4) in said cup-shaped piston (2), and an anvil (3) axially penetrating into said hollow space (4) for an axial penetration length (L), said anvil forms within an axial length of said hollow space (4) in said cup-shaped piston (2) an annular radially extending gap (X) leading into said hollow space (4) which is gas tight, for forming said anvil (3) driven axially by said piston (2) within the penetration length (L) to a point of direction reversal.

2. A pneumatic percussion operated mechanism, as set forth in claim 1, wherein a gap area formed between said anvil (3) and said piston (2) is in a range of 3% to 6% of said anvil cross-sectional area inside said piston (2).

3. A pneumatic percussion operated mechanism, as set forth in claim 1, wherein the radial dimension of the gap (X) is in the range of 0.1 mm to 0.17 mm.
